(19) United States
(12) Patent Application Publication
(10) Pub. No.: US 2025/0225476 A1
(43) Pub. Date: Jul. 10, 2025

(54) APPARATUS AND METHOD FOR PROVIDING FULFILLMENT MANAGEMENT SERVICE

(71) Applicant: NORIAND CO.,LTD., Seoul (KR)

(72) Inventor: Hyejin LEE, Gyeonggi-do (KR)

(21) Appl. No.: 18/420,700

(22) Filed: Jan. 23, 2024

(30) Foreign Application Priority Data
Jan. 5, 2024 (KR) 10-2024-0001999

(51) Int. Cl. G06Q 10/087; G06F 9/451

(52) U.S. Cl. CPC G06Q 10/087; G06F 9/451

(57) ABSTRACT

Disclosed is a method of providing a fulfillment management service, performed by a computing device including at least one processor, the method including storing a plurality of order statements related to history of a product; constructing a database using the plurality of order statements; determining a plurality of statistical information through the constructed database; and generating information for displaying at least one piece of statistical information on a screen among the determined plurality of statistical information and transmitting the generated information to a user terminal.

### CROSS-REFERENCE TO RELATED APPLICATION

This application claims priority from and the benefit of Korean Patent Application No. 10-2023-0001999 filed on Jan. 5, 2024, which is hereby incorporated by reference in its entirety.

### BACKGROUND

### Technical Field

The following example embodiments relate to a method and apparatus for providing a fulfillment management service and more particularly, to a method and apparatus for providing a fulfillment management service that may provide a solution of automatically managing fulfillment (or logistics) issues of a plurality of users running shopping malls in connection with a warehouse.

### Related Art

With the advancement of online technology, consumers may easily enjoy shopping at home. Online shopping malls are operated such that consumers may shop for a variety of products online. Online shopping malls provide an environment in which product search, purchase, and electronic payment systems are linked, allowing consumers to easily enjoy their consumption lives.

Such online shopping malls are operated by many people since there are no restrictions on opening stores. Accordingly, competition is very fierce and inefficient operation may lead to closing a business.

To efficiently run a shopping mall, an operator of the shopping mall needs to be aware of which of products being sold are selling well, which platform is more profitable for selling products, and inventory volume being held by the operator. However, as the quantity of products being sold increases, it becomes difficult for the operator to manage the products.

### SUMMARY

At least one example embodiment provides a method of providing a fulfillment management service for a user that runs an online shopping mall.

Technical objects set forth herein are not limited to the aforementioned technical objects and other technical objects not described herein may be clearly understood by one of ordinary skill in the art from the following description.

According to an aspect of at least one example embodiment, there is provided a method of providing a fulfillment management service, performed by a computing device including at least one processor, the method including storing a plurality of order statements related to history of a product; constructing a database using the plurality of order statements; determining a plurality of statistical information through the constructed database; and generating information for displaying at least one piece of statistical information on a screen among the determined plurality of statistical information and transmitting the generated information to a user terminal.

The plurality of statistical information may include sales status by day of the week, sales status by week, sales status by month, sales status by shopping mall, rankings of ordered products, inventory volume by product, stocking volume by day of the week, stocking volume by week, stocking volume by month, shipping volume by day of the week, shipping volume by week, shipping volume by month, change in product sales by period, shipping volume by region, and inventory volume by warehouse.

The generating of the information for displaying at least one piece of statistical information on the screen among the determined plurality of statistical information and the transmitting of the generated information to the user terminal may include providing information for providing a plurality of templates that constitutes an interface of the screen according to a user interaction for determining the interface of the screen; determining at least one first object providable through a first template according to a user interaction of previewing and selecting the first template among the plurality of templates; generating information for displaying, on the screen, a first template preview that includes the at least one first object and transmitting the generated information to the user terminal; constructing a user interface through the first template according to a user interaction of storing the first template; and generating information for displaying at least one piece of first statistical information on the screen through the constructed user interface and providing the generated information to the user terminal.

The fulfilment management method may further include determining inventory of at least one first product using the database; determining first safe inventory volume mapped to the at least one first product; and if the inventory is less than or equal to the first safe inventory volume, generating and providing information for displaying a guidance message of guiding purchase of the at least one first product on the screen; and may further include determining inventory of at least one first product using the database; determining first safe inventory volume mapped to the at least one first product; if the inventory is less than or equal to the first safe inventory volume, determining acquisition history in which the at least one first product is acquired; determining a seller (or store) that sold the at least one first product from the acquisition history; and transmitting an order statement that orders the at least one first product to a terminal of the store.

The database may be constructed to include a plurality of defective images in which defective products are captured, and the method may further include determining whether a first order statement related to return of a product is present among the plurality of order statements; when the first order statement is present, determining a second product included in the first order statement and a second product image in which the second product is captured; determining at least one first defective image corresponding to the second product; comparing the second product image and the at least one first defective image; when the at least one first defective image and the second product image have a similarity of a preset threshold or more as a comparison result, determining the second product as the defective product; and performing return of the second product in response to the first order statement.

In the fulfillment management method according to an example embodiment, the displaying of the at least one piece of statistical information among the determined plurality of statistical information on the screen may include displaying a recommended purchase item.

Technical solutions achievable from the present disclosure are not limited to the aforementioned solutions and other solutions not described herein may be clearly understood by one of ordinary skill in the art from the following description.

According to some example embodiments, there may be provided a method and apparatus for providing a shopping mall management service such that a user may efficiently manage an online shopping mall.

Effects achievable from the present disclosure are not limited to the aforementioned effects and other effects not described herein may be clearly understood by one of ordinary skill in the art from the following description.

### BRIEF DESCRIPTION OF THE DRAWINGS

Various aspects are described with reference to the accompanying drawings and, herein, like reference numerals refer to like elements throughout. In the following example embodiments, numerous specific details are set forth herein to provide thorough understanding of at least one aspect for the purpose of explanation. However, it will be apparent that such aspect(s) may be practiced without the specific details. In other examples, known structures and devices are illustrated in a form of a block diagram to easily describe at least one aspect:

FIG. 1 is a diagram illustrating a fulfillment management system according to some example embodiments;

FIG. 2 is a flowchart illustrating an example of a method of providing, by a computing device, a fulfillment management service according to some example embodiments;

FIG. 3 is a flowchart illustrating an example of a method of displaying, by a user terminal, statistical information on a screen according to some example embodiments;

FIG. 4 illustrates an example of a user interface according to some example embodiments;

FIG. 5 is a flowchart illustrating an example of a method of managing, by a computing device, inventory of products according to some example embodiments; and

FIG. 6 is a flowchart illustrating an example of a method of performing, by a computing device, return according to some example embodiments.

### DETAILED DESCRIPTION

Various modifications and changes may be made to the present disclosure and the disclosure may include various example embodiments. Specific example embodiments are described in detail with reference to the accompanying drawings. The example embodiments, however, may be embodied in various different forms, and should not be construed as being limited to only the specific example embodiments. Rather, the example embodiments should be understood to include all of the modifications, equivalents, and substitutions included in the spirit and technical scope of the disclosure. Like reference numerals refer to like elements throughout to describe each drawing.

Although the terms “first,” “second,” “A,” “B,” etc., may be used herein to describe various components, the components should not be limited by these terms. These terms are only used to distinguish one component from another component. For example, a first component may also be termed a second component and, likewise, a second component may be termed a first component, without departing from the scope of this disclosure. As used herein, the term “and/or” includes any and all combinations of one or more of the associated items.

When a component is referred to as being “connected to” or “accessed to” another component, the component may be directly connected to or accessed to the other component, or one or more other intervening components may be present. In contrast, when a component is referred to as being “directly connected to” or “directly accessed to,” there is no intervening component.

The terms used herein are used to simply explain specific example embodiments and are not construed to limit the present disclosure. The singular forms “a,” “an,” and “the,” are intended to include the plural forms as well, unless the context clearly indicates otherwise. It will be further understood that the terms “comprises/comprising (incudes/including),” and “has/having” when used in this specification, specify the presence of stated features, integers, steps, operations, elements, and/or components, but do not preclude the presence or addition of one or more other features, integers, steps, operations, elements, components, and/or groups, thereof.

Unless otherwise defined, all terms including technical and scientific terms used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Herein, a computing device may store a plurality of order statements related to product history. The order statement may include all information related to the product history. For example, the order statement may include a manufacturing factory in which a corresponding product is manufactured, transportation details from the manufacturing factory to a warehouse managed by a user of the computing device, order history in which the user placed an order for the product to the manufacturing factory, order history in which the user placed an order for the product in another shopping mall, history in which a consumer ordered the product through a shopping mall operated by the user, delivery information in which the product is delivered from the warehouse managed by the user to the consumer according to the consumer's order, history in which the consumer ordered the product through a platform linked to the shopping mall operated by the user, delivery information in which the product is delivered from the platform to the consumer, purchase price of the product, sales price of the product, a stock date of the product, a shipment date of the product, and the like.

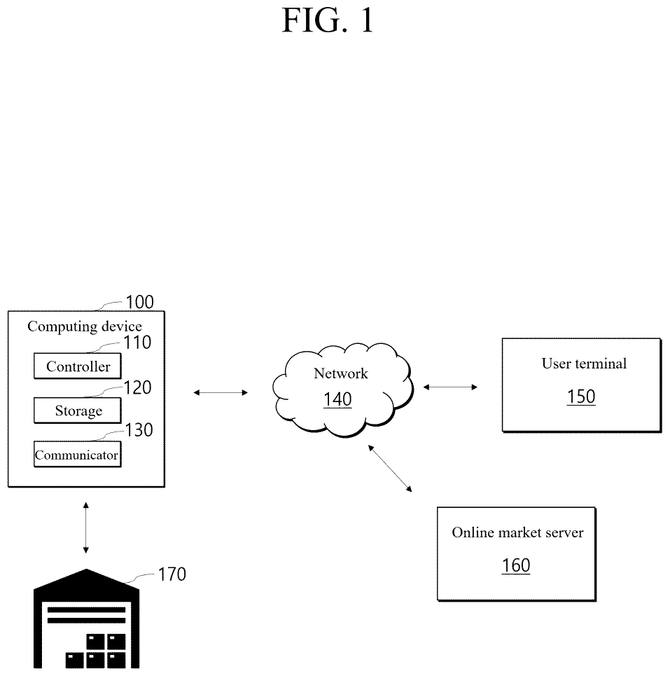

The computing device may construct a database using the stored plurality of order statements. The computing device may provide statistical information for running the shopping mall to the user using the constructed database. Therefore, the user may efficiently run the shopping mall by verifying the provided statistical information. Hereinafter, an example of a method of providing, by the computing device, a shopping mall management service according to the present disclosure is described with reference to FIGS. 1 to 6.

FIG. 1 is a diagram illustrating a fulfillment management system according to some example embodiments.

Referring to FIG. 1, the fulfillment management system may include a computing device 100 configured to provide a service for automatically managing stocking/shipping in a warehouse 170 and fulfillment (or logistics) performed in the warehouse 170 through a series of operations in connection between a user running a shopping mall and an online market while communicating with an online market server 160 and a user terminal 150 of a seller over a network 140.

The computing device 100 according to an example embodiment may include a controller 110, a storage 120, and a communicator 130. Here, the components are not essential to implement the computing device 100 and the computing device 100 may include a greater or smaller number of components than a number of the listed components.

The computing device 100 may include, for example, a microprocessor, a mainframe computer, a digital processor, and an arbitrary type of a computer system or a computer device, such as a portable device or a device controller.

The computing device 100 may achieve desired system performance using a combination of typical computer hardware (e.g., a device that may include a computer processor, a memory, a storage, an input device and an output device, and components of other existing computing device; an electronic communication device such as a router, a switch, etc.; an electronic information storage system such as a network-attached storage (NAS) and a storage area network (SAN)), and computer software (i.e., instructions that allow a computing device to operate in a specific manner).

The controller 110 may typically process an overall operation of the computing device 100. The controller 110 may provide signal, data, information, etc., input or output through the components of the computing device 100, or may provide or process information or a function suitable for a user by running an application program stored in the storage 120.

The controller 110 may include at least one core, and may include a processor for data analysis, such as a central processing unit (CPU), a general purpose graphics processing unit (GPGPU), a tensor processing unit (TPU), and the like.

Herein, the controller 110 may construct a database using a plurality of order statements from the online market server 160 and the user terminal 150. The controller 110 may determine a plurality of statistical information through the constructed database. For example, the controller 110 may determine statistical information, such as sales status by day of the week, sales status by week, sales status by month, sales status by shopping mall, rankings of ordered products, inventory volume by product, stocking volume by day of the week, stocking volume by week, stocking volume by month, shipping volume by day of the week, shipping volume by week, shipping volume by month, change in product sales by period, shipping volume by region, inventory volume by warehouse, and the like. The controller 110 may generate information for providing the determined plurality of statistical information on a screen of the user terminal 150 and may transmit the same to the user terminal 150.

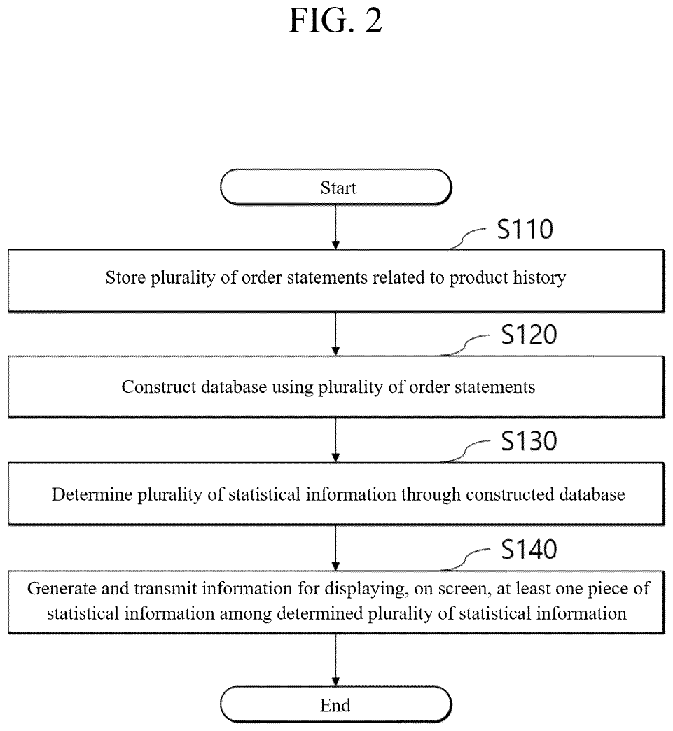

According to an example embodiment, the controller 110 may generate information for displaying at least one piece of statistical information among the determined plurality of statistical information on the screen of the user terminal 150 and may provide the generated information to the user terminal 150. For example, although all the determined plurality of statistical information is provided on the screen, the user may need only some of the statistical information. Alternatively, a space may not be enough to display all the statistical information on the screen of the user terminal 150. Therefore, the controller 110 may generate information for displaying, on the screen, at least one piece of statistical information determined by the user according to a user interaction at the user terminal 150 from the plurality of statistical information and may provide the generated information to the user terminal 150. Hereinafter, an example of a method of displaying, by the controller 110, at least one piece of statistical information on the screen is described with reference to FIG. 2.

Also, the controller 110 may provide a platform that allows the user to manage an arbitrary process related to stock and shipment of a product in the warehouse 170 through the user terminal 150. For example, the controller 110 may provide a method that allows the user to manage product ordering, to manage product stock/shipment, to manage return, to manage inventory, and to verify inventory through the user terminal 150.

The controller 110 may provide a user's company related management service. For example, the controller 110 may provide a user's business related information management, sales/purchase management, delivery management (delivery company, delivery status, box used, pickup place, etc.) service.

Also, according to an example embodiment, the controller 110 may manage sales by categorizing products sold by the user by online market type and may support a categorization and management by shopping mall. For example, the controller 110 may provide a method that allows the user to perform a unified management by connecting a sales product type (e.g., color, product type) for each online market/shopping mall and a code assigned for each online market/shopping mall. Also, the controller 110 may unify and support a process of linking inventory products in the warehouse 170 to sales products for each shopping mall, within the same platform.

Additionally, the controller 110 may provide a method of managing sales details, settlement details in an online market, tax invoice details, tax processing, and the like, through a single platform and settling a fulfillment management service usage amount using the same platform.

The storage 120 may include a memory and/or a permanent storage medium. The memory may include at least one of a flash memory type, a hard disk type, a multimedia card micro type, a card type memory (e.g., an SD or an XD memory), random access memory (RAM), static random access memory (SRAM), read-only memory (ROM), electrically erasable programmable read-only memory (EEPROM), programmable read-only memory (PROM), magnetic memory, magnetic disk, and an optical disc. The storage 120 may store a plurality of order statements related to product history.

The communicator 130 may include at least one module that enables communication between the computing device 100 and a communication system, between the computing device 100 and the user terminal 150, or between the computing device 100 and the network 140.

Hereinafter, a method of providing, by the computing device 100, a shopping mall management service is described.

Those skilled in the art may understand that the warehouse 170 may include any storehouse for stocking, storing, and shipping products upon request, and the online market server 160 may include a server linked to any open market service and a server that provides an online commerce platform, such as its own mall. The user terminal 150 refers to a terminal of a user that sells a product through an online market provided from the online market server 160 and may be implemented as an arbitrary user terminal, such as a laptop computer, a mobile phone, a smart phone, a tablet personal computer (PC), a mobile Internet device (MID), a personal digital assistant (PDA), an enterprise digital assistant (EDA), and a smart device. The smart device may be implemented as a smart watch, a smart band, or a smart ring.

FIG. 2 is a flowchart illustrating an example of a method of providing, by a computing device, a shopping mall management service according to some example embodiments.

Referring to FIG. 2, in operation S110, the controller 110 of the computing device 100 may store a plurality of order statements related to history of a product in the storage 120. Here, the order statement may be information generated in response to occurrence of new history related to the product.

For example, each of the order statements may include a manufacturing factory in which a corresponding product is manufactured, transportation details from the manufacturing factory to the warehouse managed by a user of the computing device 100, order history in which the user placed an order for the product to the manufacturing factory, order history in which the user placed an order for the product in another shopping mall, history in which a consumer ordered the product through a shopping mall (e.g., shopping mall constructed in an open market) operated by the user, delivery information in which the product is delivered from the warehouse managed by the user to the consumer according to the consumer's order, history in which the consumer ordered the product through a platform (e.g., open market platform) linked to the shopping mall operated by the user, delivery information in which the product is delivered from the platform to the consumer, purchase price of the product, sales price of the product, a stock date of the product, a shipment date of the product, and the like.

In operation S120, the controller 110 may construct a database using the plurality of order statements. In operation S130, the controller 110 may determine a plurality of statistical information through the constructed database. The statistical information may be information indicating statistics for products included in the plurality of order statements constructed as a database.

For example, the plurality of statistical information may include sales status by day of the week, sales status by week, sales status by month, sales status by shopping mall (or open market platform), rankings of ordered products, inventory volume by product, stocking volume by day of the week, stocking volume by week, stocking volume by month, shipping volume by day of the week, shipping volume by week, shipping volume by month, change in product sales by period, shipping volume by region, inventory volume by warehouse, and the like

In operation S140, the controller 110 may generate information for displaying at least one piece of statistical information among the determined plurality of statistical information on a screen of the user terminal 150 and may transmit the generated information to the user terminal 150.

For example, the controller 110 may generate and provide information for providing summary of the plurality of statistical information or a title indicating each of the plurality of statistical information on the screen of the user terminal 150. The controller 110 may determine at least one piece of statistical information according to a user interaction (on the user terminal 150) of selecting at least one piece of statistical information from among the plurality of statistical information provided on the screen. The controller 110 may generate information for displaying the determined at least one piece of statistical information on the screen of the user terminal 150 and may provide the generated information to the user terminal 150. Therefore, the user may easily verify only statistical information desired by the user.

According to an example embodiment, the plurality of statistical information may be provided in a form of a graph.

For example, the plurality of statistical information includes a Radar (or Spider Chart) form, a Pie Chart (or Donut Chart) form, a Bar Chart (or Column Chart) form, a Line Chart form, an Area Chart form, a Gantt Chart form, a Tree Map form, a Scatter Plot (or Bubble Chart) form, and a Waterfall Chart form.

Radar may be a graph used to simultaneously compare a plurality of variables. Radar may be an efficient graph form to compare various product characteristics (e.g., price, quality, popularity, etc.).

Pie Chart may be an efficient graph for showing a ratio of items belonging to a specific category. For example, Pie Chart may be an efficient graph for showing ratios of various product types in a warehouse.

Bar Chart may be a graph used to compare the number of items in each category. For example, Bar Chart may be an efficient graph for comparing the number of items maintained by warehouse location.

Line Chart may be an efficient graph to show trend over time. For example, Line Chart may be an efficient graph for showing sales trend or inventory change trend over a predetermined period of time.

Area Chart may be a graph visualized by emphasizing an area of a specific section. Area Chart may be an efficient graph for comparing cumulative data or a plurality of categories.

Gantt Chart may be a graph used to visualize a project schedule or a task progress status. Gantt Chart may be an efficient graph for managing an order processing process in a fulfillment system or planning an inventory movement schedule in a warehouse management system (WMS).

Tree Map may be a graph for displaying a size and a structure of each category to be viewed at a glance. For example, Tree Map may be an efficient graph for showing inventory quantity for various product types in a warehouse and proportion of product sales.

Scatter Plot may be a graph used to show a relationship between two variables. For example, Scatter Plot may be an efficient graph for representing a relationship between sales volume and an inventory level.

Waterfall Chart may be a graph showing a change from a start value to an end value. For example, Waterfall Chart may be used to show how final inventory quantity changes from initial inventory quantity due to order, stock, and shipment, profit and loss analysis, visualization of stepwise time change, and the like.

According to an example embodiment, the controller 110 may determine a graph for displaying at least one piece of statistical information on the screen based on a user input. The controller 110 may determine a graph form of at least one piece of statistical information according to a user interaction of selecting a graph form. The controller 110 may generate and transmit information for displaying at least one piece of statistical information on the screen of the user terminal 150 in the determined graph form.

According to an example embodiment, the controller 110 may determine a recommended purchase item based on the plurality of statistical information. For example, the controller 110 may determine a product with excellent sales volume, a product with low inventory, or a product with high shipping volume as a recommended purchase item. The controller 110 may transmit information on the determined recommended purchase item to the user terminal 150.

According to an example embodiment, the controller 110 may generate statistical information based on a pretrained artificial neural network.

According to the aforementioned configuration, the computing device 100 may determine the plurality of statistical information through the database constructed using the plurality of order statements related to product history. The computing device 100 may generate and provide information for displaying at least one piece of statistical information on the screen of the user terminal 150 among the determined plurality of statistical information. Therefore, the user may efficiently manage a shopping mall by verifying the at least one piece of statistical information displayed on the user terminal 150.

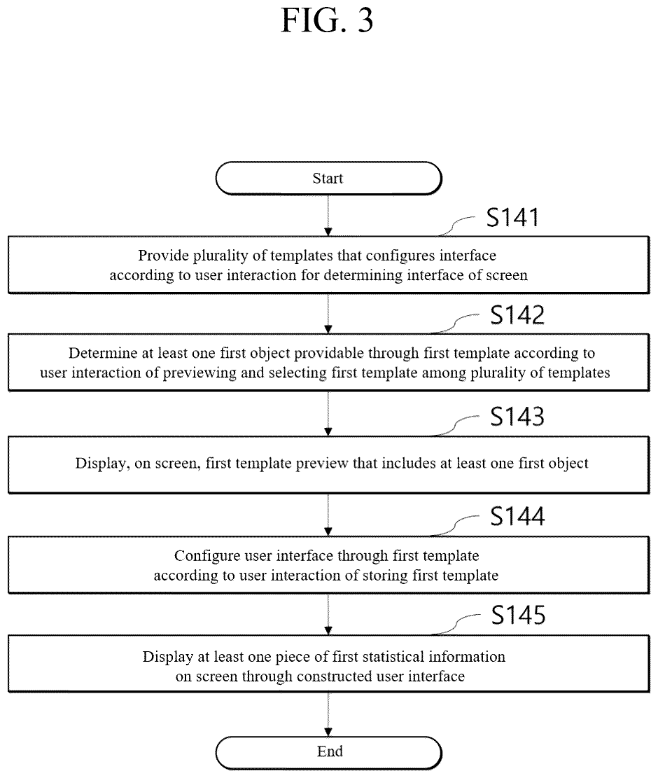

Meanwhile, according to some example embodiments, at least one piece of statistical information may be determined based on an interface of the screen displayed on the user terminal 150. The user may also determine least one piece of statistical information to be provided on the screen by selecting a single template from among a plurality of templates displayed on the user terminal 150 based on information transmitted from the computing device 100. Hereinafter, an example of a method of displaying, by a user terminal, statistical information on a screen based on information provided from the computing device 100 according to an example embodiment is described with reference to FIG. 3.

FIG. 3 is a flowchart illustrating an example of a method of displaying, by a user terminal, statistical information on a screen according to some example embodiments.

Referring to FIG. 3, in operation S141, the user terminal may provide a plurality of templates that configures an interface according to a user interaction for determining an interface of a screen. The template may be understood as an interface in which a size or an arrangement for displaying statistical information provided through the user interface is generated in advance. The computing device 100 may operate a series of information for displaying the screen according to the aforementioned operations and may transmit the same to the user terminal.

In operation S142, the user terminal may determine at least one first object providable through a first template according to a user interaction of previewing and selecting the first template among the plurality of templates. In this process, the user terminal may transmit information on the user interaction to the computing device 100, and the controller 110 of the computing device 100 may transmit a series of information for displaying the first object corresponding to the user interaction to the user terminal.

For example, a different object may be provided for each of the plurality of templates. The object may be understood as a screen component provided through the user interface. For example, the first template among the plurality of templates may be a template in which at least one first object is displayed. As another example, a second template among the plurality of templates may be a template in which at least one second object is displayed. As still another example, a third template among the plurality of templates may be a template in which at least one third object is displayed. The controller 110 may determine at least one first object providable through the first template according to a user interaction of previewing and selecting the first template among the plurality of templates and may transmit information for displaying the determined first object to the user terminal.

In operation S143, the user terminal may display, on the screen, a first template preview that includes at least one first object. In operation S144, the user terminal may configure the user interface through the first template according to a user interaction of storing the first template. In this process, the user terminal may autonomously perform an arithmetic operation and may transmit information on the user interaction of storing the first template to the computing device 100 and may receive a series of information for interface configuration from the computing device 100 and then may configure the interface.

For example, the user terminal may configure the user interface that includes at least one first object.

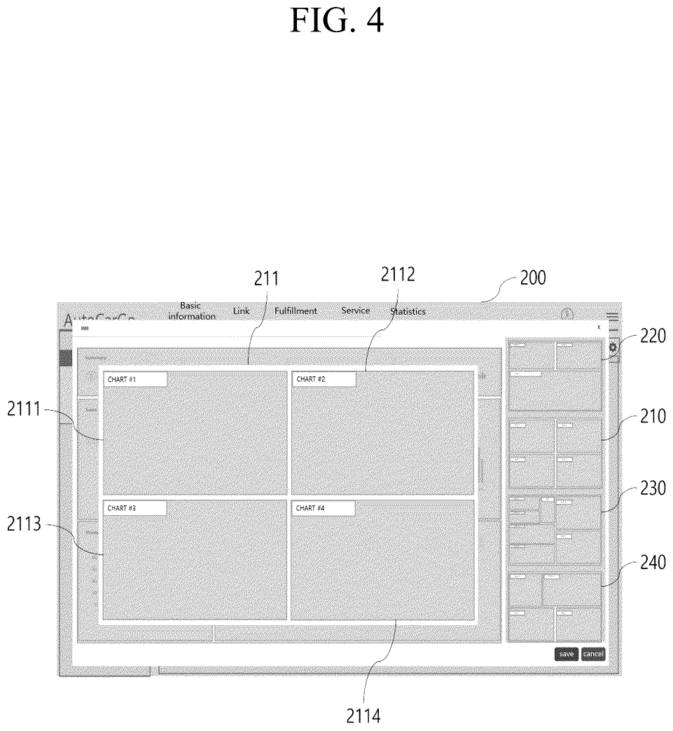

In operation S145, the user terminal may display at least one piece of first statistical information on the screen through the constructed user interface. For clarity of description, FIG. 4 may be referred to. In this process, the user terminal may receive a series of information for displaying the first statistical information from the computing device 100.

FIG. 4 illustrates an example of a user interface according to some example embodiments.

Referring to FIG. 4, according to a user interaction of determining an interface of a screen 200, the controller 110 may generate information for displaying a plurality of templates 210, 220, 230, and 240 constituting the interface and may provide the generated information to a user terminal.

According to a user interaction of previewing and selecting the first template 210 among the plurality of templates 210, 220, 230, and 240, the controller 110 may generate information for displaying a first template preview 211 on the screen and may provide the generated information to the user terminal. The first template preview 211 may include at least one first objects 2111, 2112, 2113, 2114 providable through the first template 210. Information generated according to the user interaction of storing the first template 210 (interaction on the user terminal) may be transmitted to the computing device 100, and the controller 110 may configure the user interface through the first template 210. To configure the user interface, the controller 110 may receive, from the user terminal, information on a user interaction of selecting at least one piece of first statistical information to be included in each of the at least one first object 2111, 2112, 2113, 2114. The controller 110 may generate information for displaying at least one piece of first statistical information on the screen through the constructed user interface and may transmit the generated information to the user terminal.

Meanwhile, according to some example embodiments, the controller 110 may determine a graph form in which at least one piece of first statistical information is displayed.

For example, to construct the user interface, the controller 110 may receive, from the user terminal, information on the user interaction of selecting at least one piece of first statistical information to be included in each of the at least one first object 2111, 2112, 2113, 2114. The controller 110 may receive, from the user terminal, information on the user interaction of determining a graph form in which the at least one piece of first statistical information is displayed. The controller 110 may generate information for displaying the at least one piece of first statistical information on the screen of the user terminal through the constructed user interface and may provide the generated information to the user terminal.

According to an example embodiment, providable at least one piece of statistical information may be predetermined for each of the plurality of templates.

For example, the first template 210 among the plurality of templates may be a template in which the at least one piece of first statistical information is displayed through the at least one first object 2111, 2112, 2113, 2114. As another example, the second template 220 among the plurality of templates may be a template in which at least one piece of second statistical information is displayed through at least one second object. As another example, the third template 230 among the plurality of templates may be a template in which at least one piece of third statistical information is displayed through at least one third object.

According to another example embodiment, providable at least one piece of statistical information and a graph form in which the at least one piece of statistical information is displayed may be predetermined for each of the plurality of templates.

For example, the first template 210 among the plurality of templates may be a template in which the at least one piece of first statistical information is displayed in a first graph form through the at least one first object 2111, 2112, 2113, 2114. As another example, the second template 220 among the plurality of templates may be a template in which the at least one piece of second statistical information is displayed in a second graph form through the at least one second object. As another example, the third template 230 among the plurality of templates may be a template in which. the at least one third statistical information is displayed in a third graph form through the at least one third object.

According to the aforementioned configuration, the computing device 100 may transmit information for providing the plurality of templates for constructing the user interface to the user terminal. The computing device 100 may generate information for providing at least one piece of statistical information among the plurality of statistical information to match the selected template and may transmit the generated information to the user terminal. Therefore, the user may build a screen style that suits the user and may manage a shopping mall. For example, the computing device 100 may provide a shopping mall management page customized for each user through the aforementioned interface. In detail, depending on the user's needs, the aforementioned user interface may be configured to include information on stocking/shipping volume by month, proportion of inventory volume by product, change in product sales by period, and inventory volume by region/warehouse. Here, individual information may be added/deleted according to a selection from the user.

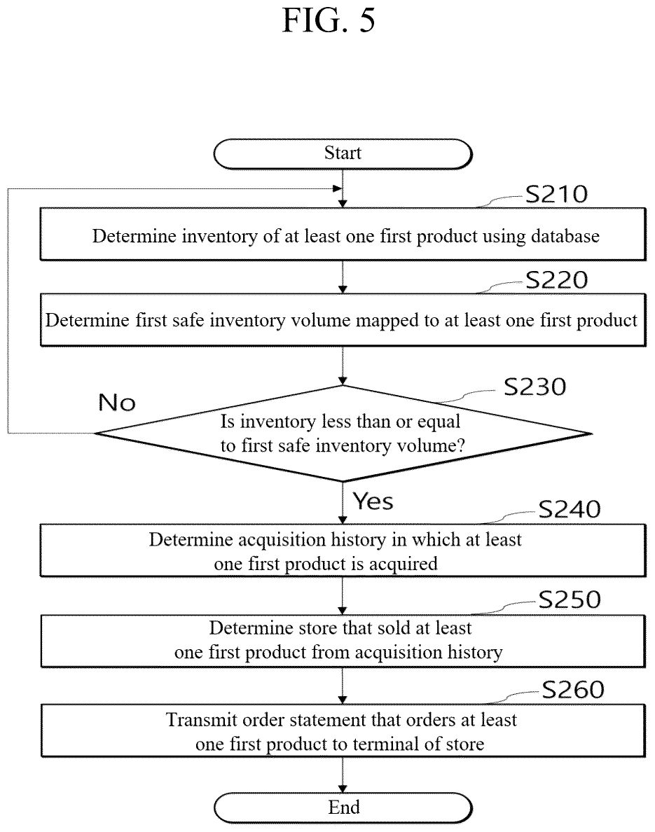

Meanwhile, according to some example embodiments, the computing device 100 may provide a function of managing inventory of products using the constructed database. Hereinafter, an example of a method of managing, by a computing device, inventory of products according to the present disclosure is described with reference to FIG. 5.

FIG. 5 is a flowchart illustrating an example of a method of managing, by a computing device, inventory of products according to some example embodiments.

Referring to FIG. 5, in operation S210, the controller 110 of the computing device 100 may determine inventory of at least one first product using a database. In operation S220, the controller 110 may determine first safe inventory volume mapped to the at least one first product. Here, safe inventory volume may be quantity pre-mapped to each of products managed by the computing device 100.

For example, it may be assumed that monthly shipping volume of the at least one first product is 100. In this case, the first safe inventory volume may be pre-mapped, such as 120.

According to an example embodiment, the controller 110 may determine the safe inventory volume by product based on at least one piece of statistical information.

For example, the controller 110 may determine that 100 first products are sold on Monday based on statistical information on sales status by day of the week. In this case, the controller 110 may predetermined that the first safe inventory volume of the first product is 120.

If the inventory is less than or equal to the first safe inventory volume (i.e., yes) in operation S230, the controller 110 may determine acquisition history in which the at least one first product is acquired in operation S240.

In detail, the controller 110 may determine acquisition history in which at least one first product is acquired based on a first order statement related to the at least one first product. The acquisition history may include purchase history or manufacturing history.

For example, the acquisition history may include a manufacturing factory in which the at least one first product is manufactured, transportation details from the manufacturing factory to a warehouse managed by a user of the computing device 100, and order history in which the user placed an order for the at least one first product to the manufacturing factory.

As another example, the acquisition history may include order history in which the user placed an order for the at least one first product in another shopping mall.

According to an example embodiment, if the inventory is less than or equal to the first safe inventory volume (i.e., yes) in S230, the controller 110 may generate information for displaying a guidance message of guiding purchase of the at least one first product on the screen of the user terminal and may transmit the generated information to the user terminal.

If the inventory is greater than the first safe inventory volume (i.e., no) in operation S230, the controller 110 may not determent the acquisition history of the at least one first product.

In operation S250, the controller 110 may determine a store that sold the at least one first product from the acquisition history.

For example, when the at least one first product is a product acquired from a manufacturing factory, the controller 110 may determine the manufacturing factory as the corresponding store.

As another example, when the at least one first product is a product purchased in another shopping mall, the controller 110 may determine the other shopping mall as the corresponding store.

In operation S260, the controller 110 may transmit an order statement that orders the at least one first product to a terminal of the store.

For example, the controller 110 may generate the order statement using order history in which the user placed an order for the at least one first product to the manufacturing factory. The controller 110 may transmit the generated order statement to the terminal of the store.

As another example, the controller 110 may generate the order statement using order history in which the user placed an order for the at least one first product in another shopping mall. The controller 110 may transmit the generated order statement to the terminal of the store. In this process, in the case of automatic ordering, if preset by the user, automatic ordering may be performed according to set criteria. Alternatively, depending on example embodiments, a notification may be provided to the user terminal to inquire whether automatic ordering proceeds and if conformation is made by the user, automatic ordering may be performed.

According to the aforementioned configuration, the computing device 100 may determine inventory and safe inventory volume of each of the plurality of products. If the inventory is determined to be less than or equal to the safe inventory volume, the computing device 100 may generate an order statement for ordering each of the plurality of products. The computing device 100 may transmit the generated order statement to a terminal of a corresponding store. Therefore, the user may conveniently operate a shopping mall without a need to directly manage product inventory.

According to an example embodiment, the computing device 100 may provide safe inventory recommendation information in light of sales trend of a target item. For example, the computing device 100 may determine time-series sales volume of an item corresponding to the target item in the online market server 160 and, when the time-series sales volume decreases by a preset threshold or more, may provide recommendation information that recommends decline trend and safe inventory adjustment, which may allow the user to easily manage inventory.

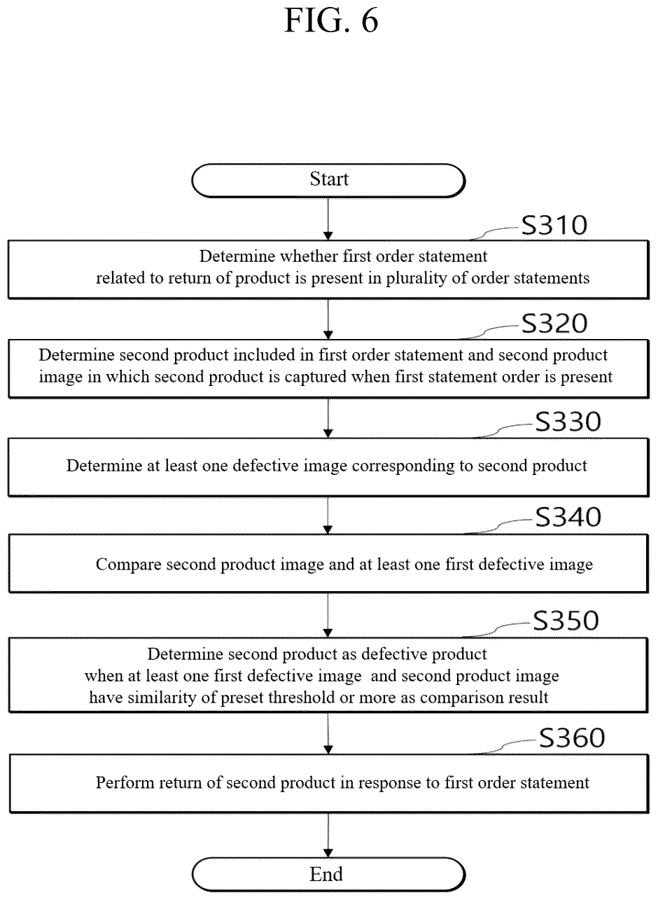

Meanwhile, according to some example embodiments, the computing device 100 may determine whether to perform return of at least one product. Hereinafter, an example of a method of performing, by a computing device, return according to the present disclosure is described with reference to FIG. 6.

FIG. 6 is a flowchart illustrating an example of a method of performing, by a computing device, return according to some example embodiments.

Referring to FIG. 6, in operation S310, the controller 110 of the computing device 100 may determine whether a first order statement related to return of a product is present in a plurality of order statements. When the first order statement is present, the controller 110 may determine a second product included in the first order statement and a second product image in which the second product is captured in operation S320. Here, the second product may be a product purchased by the user that requests return. The second product image may be an image in which the second product is captured by the user.

In operation S330, the controller 110 may determine at least one first defective image corresponding to the second product.

In detail, a database may be constructed to include a plurality of defective images in which defective products are captured. For example, when a plurality of second products is stocked in a shopping mall, the controller 110 may acquire at least one first defective image related to the plurality of second products. The at least one first defective image may be an image in which a defective product among the plurality of second products is captured at various angles. The at least one first defective image may be an image in which the plurality of second products with different defects are captured. The controller 110 may construct the database using the acquired at least one first defective image. According to an example embodiment, the database for the first defective image may be constructed differently for each user. For example, even for the same product, a first user that runs a first shopping mall may determine the second product as a defective product, but a second user that runs a second shopping mall corresponding to a shopping mall different from the first shopping mall may determine the second product as a non-defective product. To this end, the controller 110 may individually collect the first defective image (e.g., six sides of product) corresponding to status of each product being treated as a defective product for each shopping mall operator and may store the collected first defective images on a separate database for each user.

In operation S340, the controller 110 may compare the second product image and the at least one first defective image. When the at least one first defective image and the second product image have a similarity of a preset threshold or more as a comparison result, the controller 110 may determine the second product as the defective product in operation S350. In this case, the controller 110 may perform return of the second product in response to the first order statement in operation S360. According to an example embodiment, the controller 110 may input the second product image and the at least one first defective image into a pretrained first artificial neural network and may determine whether the second product is defective. To this end, an artificial neural network may use the second product image of which defective status is labeled based on the first defective image and the first defective image as input and may be pretrained to minimize a loss function calculated based on a determination result for the output defective status and a labeling result.

According to an example embodiment, return may include exchange or refund.

For example, the first order statement may be a statement related to exchange of the product. When the at least one first defective image and the second product image have the similarity of the preset threshold or more, the controller 110 may send, to the user, the second product classified as a non-defective product based on the first order statement.

As another example, the first order statement may be a statement related to refund of the product. When the at least one first defective image and the second product image have the similarity of the preset threshold or more, the controller 110 may proceed with a refund procedure for the second product based on the first order statement.

According to the aforementioned configuration, when an order statement related to refund of a product is received, the computing device 100 may determine whether the product purchased by the user is defective. Also, when the product purchased by the user is defective, the computing device 100 may perform refund in response to the order statement. Therefore, the user may conveniently operate the shopping mall without a need to directly manage product return. Before the preceding operation is performed, unpacking and item classification processes for a previously returned product package may be automated.

According to an example embodiment, when the second product determined to be defective is stocked from a consumer to a warehouse, the computing device 100 may perform unpacking for the second product through an automated machine and may acquire a returned product image for the unpacked second product through a camera provided in the warehouse. According to an example embodiment, the computing device 100 may reexamine whether the returned product is defective by inputting the returned product image into the first artificial neural network. When the second product is determined to be defective even as a result of determining whether the returned product image is defective, the computing device 100 may perform return/exchange according to a determination that is made through the aforementioned procedure.

The computing device 100 may determine a postprocessing direction for the second product through input to a second artificial neural network pretrained to determine the postprocessing direction based on the returned product image. The second artificial neural network may be pretrained to determine the postprocessing direction (e.g., at least one of first status, second status, and third status) of the returned product by using, as learning data, the returned product image labeled with at least one of the first status corresponding to disposal, the second status corresponding to a general defective condition that allows a further distribution, such as discount sales and sales after repair, and the third status corresponding to a condition that allows immediate restocking as a good product and reference images corresponding to the first status, the second status, and the third status, and to minimize a loss function that is calculated based on the determined postprocessing direction and labeling. The computing device 100 may process the returned second product based on a calculation result of the second artificial neural network.

According to an example embodiment, the computing device 100 may additionally provide recommendation information on a processing direction for the second product that is determined as the second status in a previous operation. For example, the computing device 100 may provide recommendation information on a returned product processing direction based on output of a third artificial neural network that is pretrained to predict status information and a discount rate of the returned product by using the returned product image as input. For example, the third artificial neural network may be pretrained to output status information and a discount rate of the returned product based on status information (e.g., information on a defective part and information on a degree of defect) of the product corresponding to the returned product image and learning data labeled with a discount rate predetermined for each status information (e.g., sum of discount rates predetermined according to the defective part and degree of defect corresponding to the defective part).

According to an example embodiment, the computing device 100 may provide a matching service for processing a returned product based on a defective image databased for each customer. For example, a first seller may judge the second product to be defective and a second seller may not judge the second product to be defective. Therefore, when the second product sold by the first seller is determined to be defective based on the defective image databased for each customer, the computing device 100 may determine the second seller that does not judge the second product to be defective based on the defective image databased for each customer and may provide a method for mutual communication to enable a transaction between the first seller and the second seller. For example, a chat channel may be formed between the first seller and the second seller. It will be understood by one skilled in the art that a method of supporting the mutual communication is not limited to opening a mutual chat channel and may include a method of generating an arbitrary communication channel, such as sharing mutual contact information and judgement information on the defective product.

According to an example embodiment, the computing device 100 may additionally provide fulfillment (or logistics) recommendation information. Since the computing device 100 manages stock/shipment of companies and delivery data related thereto in the warehouse, the computing device 100 may provide fulfillment (or logistics) recommendation information to support more efficient fulfillment. In detail, when item delivery of the second user is scheduled within a distance of a predetermined threshold or less from area A on the same day in the warehouse in a situation in which the first user needs to deliver an item to area A, the computing device 100 may recommend to use a first delivery company used by the second user. In this process, the computing device 100 may relay a contract such that the first user may make a delivery contract at a price to which a predetermined discount rate is applied according to efficiency of delivery and a predetermined incentive (e.g., coupon or delivery cost discount) may be provided to the second user. In the aforementioned example, the discount rate applied to the first user may be preset to be inversely proportional to a distance between a delivery area of the second user and a delivery area of the first user. Depending on example embodiments, delivery schedules of the first user and the second user do not need to be the same and the computing device 100 may also determine a user of which delivery is scheduled within a predetermined critical period.

According to an example embodiment, when the computing device 100 receives settings for a target item from the user terminal 150, the computing device 100 may periodically transmit lowest price information on a target item to the user terminal 150. For example, the computing device 100 may search for the lowest price information for the target item in domestic and foreign online markets at preset intervals and may transmit the same to the user terminal 150 and the user may use the information to consider changing an inventory ordering company.

Also, the computing device 100 may periodically request a quotation from a company that sells the target item and may transmit the same to the user terminal 150. For example, the computing device 100 may inquire about companies selling the target item to a pretrained generative artificial intelligence model (e.g., CHAT GPT), may acquire a list of corresponding companies, may crawl email addresses of the companies included in the list, and may transmit emails that request a quotation for the target item and confirmation of product delivery deadlines through the crawled email addresses. The computing device 100 may periodically provide the user with a list of companies that provide a quote lower than the price at which the user is currently transacting, among emails responded over a predetermined period of time. In this process, the computing device 100 may periodically provide the user with information in which information on fulfillment (or logistics) cost and time used according to distance is additionally applied.

In the previous process of verifying the quotation, the computing device 100 may additionally provide a preliminary verification on reliability of a company subject to the quotation using an application programming interface (API) of a plurality of map services and may additionally provide a verification result to the user. For example, the computing device 100 may search for a company name and search for a first address of a company using an API of a first map service for each of companies included in a company list acquired from a generative artificial intelligence model, may search for a company name and search for a second address using an API of a second map service, may search for a company name and search for a third address using an API of a third map service, and may verify whether the found addresses match and whether searching is not performed, and may additionally provide confirmed information to the user. The number of map services used is not limited to the above example, and one of ordinary skill in the art may understand that a larger number of address search services may be used.

Also, the computing device 100 may relay a transaction between companies using the warehouse 170 managed by the computing device 100. For example, in the process of securing inventory, processing a defective product, or proceeding with new stock, the computing device 100 may provide recommendation information on companies using the warehouse 170 managed by the computing device 100. Here, the warehouse 170 may be any warehouse that is managed through a service provided from the computing device 100, in addition to the same warehouse. The computing device 100 may relay a mutual transaction by providing the user with information on companies that treat products the first user needs to stock or sell (e.g., product type information, product price information, and the like) and may provide a method of saving fulfillment (or logistics) cost arising from a separate order.

The example embodiments described herein may be implemented using hardware components, software components, and/or combination of the hardware components and the software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to the example embodiments may be recorded in non-transitory computer-readable media including program instructions to implement various operations embodied by a computer. Also, the media may include, alone or in combination with the program instructions, data files, data structures, and the like. Program instructions stored in the media may be those specially designed and constructed for the example embodiments, or they may be well-known and available to those having skill in the computer software arts. Examples of the media include magnetic media such as hard disks, floppy disks, and magnetic tapes; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The hardware device may be configured to operate as at least one software module to perform operations of the example embodiments, or vice versa.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A method of providing a fulfillment management service, performed by a computing device comprising at least one processor, the method comprising:
storing a plurality of order statements related to history of a product;
constructing a database using the plurality of order statements;
determining a plurality of statistical information through the constructed database; and
generating information for displaying at least one piece of statistical information on a screen among the determined plurality of statistical information and transmitting the generated information to a user terminal.

2. The method of claim 1, wherein the plurality of statistical information includes sales status by day of the week, sales status by week, sales status by month, sales status by shopping mall, rankings of ordered products, inventory volume by product, stocking volume by day of the week, stocking volume by week, stocking volume by month, shipping volume by day of the week, shipping volume by week, shipping volume by month, change in product sales by period, shipping volume by region, and inventory volume by warehouse.

3. The method of claim 1, wherein the generating of the information for displaying at least one piece of statistical information on the screen among the determined plurality of statistical information and the transmitting of the generated information to the user terminal comprises:
providing information for providing a plurality of templates that constitutes an interface of the screen according to a user interaction for determining the interface of the screen;
determining at least one first object providable through a first template according to a user interaction of previewing and selecting the first template among the plurality of templates;
generating information for displaying, on the screen, a first template preview that includes the at least one first object and transmitting the generated information to the user terminal;
constructing a user interface through the first template according to a user interaction of storing the first template; and
generating information for displaying at least one piece of first statistical information on the screen through the constructed user interface and providing the generated information to the user terminal.

4. The method of claim 1, further comprising:
determining inventory of at least one first product using the database;
determining first safe inventory volume mapped to the at least one first product; and
if the inventory is less than or equal to the first safe inventory volume, generating and providing information for displaying a guidance message of guiding purchase of the at least one first product on the screen; and
further comprising:
determining inventory of at least one first product using the database;
determining first safe inventory volume mapped to the at least one first product;
if the inventory is less than or equal to the first safe inventory volume, determining acquisition history in which the at least one first product is acquired;
determining a store that sold the at least one first product from the acquisition history; and
transmitting an order statement that orders the at least one first product to a terminal of the store.

5. The method of claim 1, wherein the database is constructed to include a plurality of defective images in which defective products are captured, and
the method further comprises:
determining whether a first order statement related to return of a product is present among the plurality of order statements;
when the first order statement is present, determining a second product included in the first order statement and a second product image in which the second product is captured;
determining at least one first defective image corresponding to the second product;
comparing the second product image and the at least one first defective image;
when the at least one first defective image and the second product image have a similarity of a preset threshold or more as a comparison result, determining the second product as the defective product; and
performing return of the second product in response to the first order statement.
